(19) United States
(12) Patent Application Publication
(10) Pub. No.: US 2007/0047226 A1
(43) Pub. Date: Mar. 1, 2007

(54) LED module and backlight system having the same

(75) Inventor: Tai-Cherng Yu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/377,697

(22) Filed: Mar. 16, 2006

(30) Foreign Application Priority Data
Aug. 26, 2005 (CN) 200510036914.4

(51) Int. Cl. F21V 9/00

(52) U.S. Cl. 362/231; 362/235

(57) ABSTRACT

The present invention relates to a light emitting diode (LED) module. The LED module includes a circuit board, two first LEDs for emitting light of a first color component, two second LEDs for emitting light of a second color component, and a third LED for emitting light of a third color component. The first, second and third LEDs are electrically connected with the circuit board, the first LEDs and the second LEDs are configured in a shape of a rectangle and each LED respectively occupies a corner of the rectangle, the first LEDs are arranged diagonally opposite each other, the second LEDs are also arranged diagonally opposite each other, and the third LED is arranged at a center of the rectangle.

### BACKGROUND OF THE INVENTION

1. Technical Field

The present invention relates to light sources, and particularly to a light emitting diode (LED) module and a backlight system having the same.

2. Discussion of the Related Art

LEDs are semiconductors that convert electrical energy into light. Compared to conventional light sources, LEDs generate relatively little heat; have high energy conversion efficiency, high radiance (that is, they emit a large quantity of light per unit area), long service lifetime, high response speed, and good reliability.

It is known that white light is a mixture of different wavelengths across the visible light spectrum. Traditional LEDs cannot produce white light, instead, each LED can produce only light in one very narrow frequency band. Generally, a combination of light in the three primary colors, i.e. a mixture of red, green, and blue light produces white light. In fact, any color of light may be produced with an appropriate combination of these three colors of light. By combining these red, green, and blue LEDs in a tightly coupled pattern, a crude form of white light is produced. Theoretically, by adjusting the relative intensity of the light emitted by the red, green, and blue LEDs, any color light source can be obtained.

Referring to FIG. 1 and FIG. 2, a conventional backlight system including a backlight source with LED modules is shown. The backlight system 10 includes a reflecting cavity 11, a number of LED modules 12, a diffusion board 13, a diffusion plate 14, a light collector 15 and a dual brightness enhancement film 16. The reflecting cavity 11 includes a bottom surface and several side surfaces. The LED modules 12 are configured in an array. The diffusion board 13 is configured on a top of the reflecting cavity 11 and is parallel with the bottom surface of the reflecting cavity 11. The diffusion plate 14, the light collector 15 and the dual brightness enhancement film 16 are disposed on the diffusion board 13 in sequence. Light beams emitted from the LED modules 12 can be converted into a surface light source via the diffusion board 13, thus a surface light source composed of uniform distribution light beams can be obtained.

Generally, in the LED module 12, a number of LEDs are arranged in a linear format or in a circular format. Referring to FIG. 3, a conventional LED module 22 includes seven LEDs, i.e., two blue LEDs, four green LEDs and one red LED. The two blue LEDs and the four green LEDs are arranged around the red LED in a circular format. Alternatively, the number of the LEDs is variable, for example, FIG. 4 shows a LED module 32 including four green LEDs and three blue LEDs disposed along a circular format, and one red LED disposed at a center thereof.

Compared with the linear format LED module, the circular format LED module can emit light beams with higher luminance and higher purity of the white light. But the circular format LED module generally needs seven to nine LEDs, thus, an electric circuit connection between the LEDs and the circuit board become much complex.

It is desired to provide a LED module that overcomes the above-described problems.

### SUMMARY

A light emitting diode (LED) module includes a circuit board, two first LEDs for emitting light of a first color component, two second LEDs for emitting light of a second color component, and a third LED for emitting light of a third color component. The first, second and third LEDs are electrically connected with the circuit board, the first LEDs and the second LEDs are configured in a shape of a rectangle and each LED respectively occupies a corner of the rectangle, the first LEDs are arranged at diagonally opposite each other, the second LEDs are also arranged at diagonally opposite each other, and the third LED is arranged at a center of the rectangle.

A backlight system including a plurality of above-described LED modules is also provided.

Advantages and novel features will become more apparent from the following detailed description when taken in conjunction with the accompanying drawing.

### BRIEF DESCRIPTION OF THE DRAWING

Many aspects of the present LED module and backlight system having the same can be better understood with reference to the following drawings. The components in the drawings are not necessarily drawn to scale, the emphasis instead being placed upon clearly illustrating the principles of the present LED module and backlight system. Moreover, in the drawings, like reference numerals designate corresponding parts throughout the several views.

FIG. 1 is a schematic, side view of a conventional backlight system;

FIG. 2 is a schematic, plane view showing a configuration of LED modules in the backlight system of FIG. 1;

FIG. 3 is a schematic, plane view of a LED module of FIG. 2;

FIG. 4 is similar to FIG. 3, but showing another conventional LED module of FIG. 2;

FIG. 5 is a schematic, plane view of a LED module, in accordance with a first preferred embodiment;

FIG. 6 is a schematic, side view of a backlight system having LED modules of FIG. 5; and

FIG. 7 is a schematic, plane view showing a configuration of LED modules in the backlight system of FIG. 6.

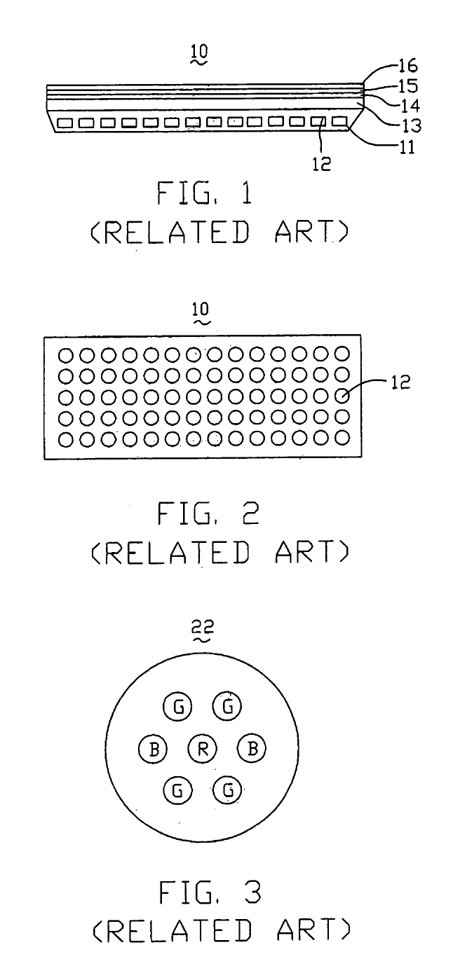

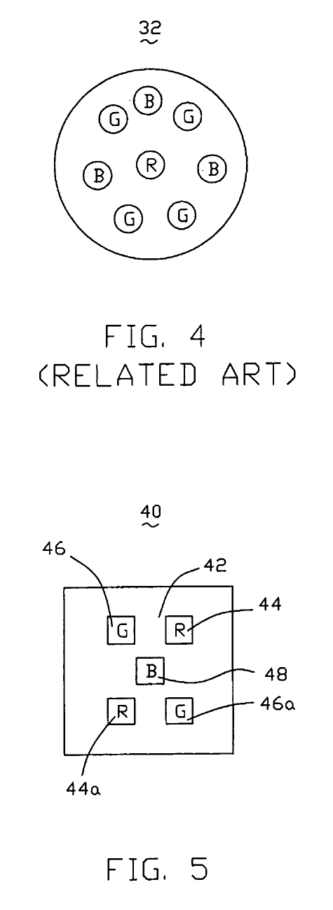

### DETAILED DESCRIPTION OF THE PREFERRED EMBODIMENT

FIG. 5 shows a LED module 40 in accordance with a first exemplary embodiment. The LED module 40 includes a circuit board 42 and five light emitting units such as five LEDs mounted on a surface of the circuit board 42. The five LEDs are electrically connected with the circuit board 42, and include two red LEDs 44, 44a capable of emitting red light, two green LEDs 46, 46a capable of emitting green light, and a blue LED 48 capable of emitting blue light.

The five LEDs can be electrically connected with the circuit board 42 via for example a thermally conductive grease. The red LEDs 44, 44a and green LEDs 46, 46a are configured in a shape of a rectangle and each LED respectively occupies a corner of the rectangle. The red LEDs 44, 44a are arranged at diagonally opposite corners of the rectangle, while the green LEDs 46, 46a are also arranged at diagonally opposite corners of rectangle. The blue LED 48 is disposed at a center of the rectangle.

The circuit board 42 may be a printed circuit board. A driver circuit is configured on one surface of the circuit board 42. A series loop can be formed by the five LEDs connected in series with the circuit board 42. The five LEDs including the green LED 46, the red LED 44, the blue LED 48, the red LED 44a, and the green LED 46a may be connected in series.

The driver circuit of the circuit board 42 can provide a driver current for controlling the five LEDs to emit white light. Through adjusting the light intensity and color levels of each LED, a desired white light can be produced. Because the LEDs are configured into a rectangle format, advantages including uniform brightness and high luminance are achieved. Thus this LED module 40 can obtain high purity white light.

Alternatively, the five LEDs aligned on the circuit board 42 may be one red LED, two blue LEDs and two green LEDs. Similarly, the two blue LEDs and the two green LEDs are disposed at four corners of a rectangle, wherein, the two LEDs emitting a same color component are configured diagonally opposite each other. The red LED is located at the center of the rectangle. In summary, the LED module 40 includes two first LEDs for emitting light of a first color component, two second LEDs for emitting light of a second color component, and one third LED for emitting a third color component. The three color components are three primary colors, i.e., red, green and blue. The five LEDs are mounted on the circuit board 42 in a rectangle format, that is, the third LED is disposed at the center of the rectangle, the first and second LEDs are disposed at four corners of the rectangle. More specifically, the first LEDs are arranged at two diagonally opposite corners of the rectangle, while the second LEDs are also arranged at two diagonally opposite corners of the rectangle.

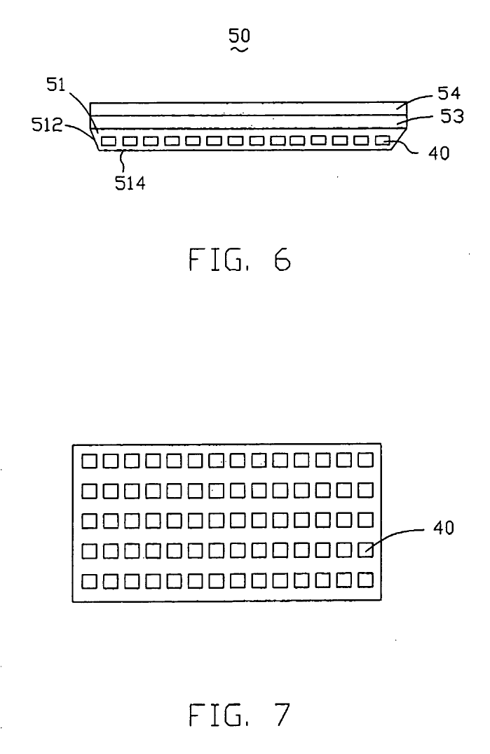

Referring to FIG. 6 and FIG. 7, a backlight system 50 is illustrated in accordance with a second exemplary embodiment. The backlight system 50 includes a reflecting cavity 51, a diffusion plate 53, a light collector 54 and several LED modules 40. The reflecting cavity 51 is defined by a reflecting bottom plate 514 and diffusion plate 53. The side plates 512 are configured adjacent to the reflecting bottom plate 514, an opening of the reflecting cavity 51 defined opposite to the reflecting bottom plate 514. The diffusion plate 53 is arranged close to the opening of the reflecting cavity 51, thereby forming a close cavity body. The light collector 54, e.g. a prism sheet, is arranged upside of the diffusion plate 53. The LED modules 40 are configured in an array inside the reflecting cavity 51, and in a direction toward the diffusion plate 53.

Preferably, a brightness enhancement film may be configured on the light collector 54 for promoting luminance of the white light from the backlight system 50. In addition, a high reflectance film may be applied to the side plates 512 to further promote reflective efficiency of the reflecting cavity 51.

A material of the circuit board 42 may be high thermally conductive metal for dispersing a heat energy produced by the five LEDs to the whole circuit board 42, in this way the heat of point heat sources like the five LEDs is transformed into the surface and becomes a surface heat sources, thus facilitating energy dispersal. The high thermally conductive metal may be copper, aluminum or an alloy of such metals.

In the present light source device, five LEDs on the LED module 40 arranged into a rectangle format, one third LED is disposed at the center of the rectangle, the first and second LEDs are disposed at four corners of the rectangle. More specifically, the first LEDs are arranged at two diagonally opposite corners of the rectangle, while the second LEDs are also arranged at two diagonally opposite corners of the rectangle. Thus in this arrangement of the five LEDs, a high quality white light can be obtained.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light emitting diode (LED) module comprising:
a circuit board;
two first LEDs for emitting light of a first color component;
two second LEDs for emitting light of a second color component; and
a third LED for emitting light of a third color component;
wherein the first, second and third LEDs are electrically connected with the circuit board, the first LEDs and the second LEDs are configured in a shape of a rectangle and each LED respectively occupies a corner of the rectangle, the first LEDs are arranged diagonally opposite each other, the second LEDs are arranged diagonally opposite each other, and the third LED is arranged at a center of the rectangle.

2. The LED module as described in claim 1, further comprising a thermally conductive grease applied between at least of the first, second and third LEDs and the circuit board.

3. The LED module as described in claim 1, wherein the first, second and third LEDs are electrically connected in series.

4. A backlight system comprising a plurality of LED modules as described in claim 1.

5. The backlight system as described in claim 4, further comprising a reflecting bottom plate, wherein, the LED modules are configured on the reflecting bottom plate.

6. The backlight system as described in claim 5, wherein the LED modules are arranged in an array on the reflecting bottom plate.

7. The backlight system as described in claim 5, further comprising a diffusion plate arranged on the reflecting bottom plate, the reflecting bottom plate and the diffusion plate cooperatively defining a reflecting cavity therebetween.

8. The backlight system as described in claim 7, further comprising a light collector configured on the diffusion plate.
